(19) United States
(12) Patent Application Publication
(10) Pub. No.: US 2008/0247282 A1
(43) Pub. Date: Oct. 9, 2008

(54) Method of Data Protection

(75) Inventor: Chih-Wei Chen, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: INVENTEC CORPORATION, Taipei City (TW)

(21) Appl. No.: 11/697,845

(22) Filed: Apr. 9, 2007

(51) Int. Cl. G11B 20/18

(52) U.S. Cl. 369/47.14; 369/30.01

(57) ABSTRACT

A method of data protection is used in a data processing system having a storage device. According to the method, when the data processing system reads a damaged storage block in the storage device, it finds the surrounding storage blocks of the damaged block and determines in sequence whether any of the surrounding blocks is damaged. If none of them is damaged, then the data processing system determines whether those surrounding blocks are not in use. If they are not in use, then the data processing system defines them as being in use. If they are already in use, then the data processing system searches unused storage blocks in the storage device, duplicates the data in the surrounding blocks to the unused blocks, and then define the unused blocks as being in use. Finally, the data processing system establishes a correspondence relation between the surrounding blocks and the unused blocks. Therefore, when the data processing system accesses the surrounding blocks, it obtains data stored in the unused blocks through the correspondence relation.

### BACKGROUND OF THE INVENTION

1. Field of Invention

The invention relates to a method of data protection. More explicitly, the data protection method is used in a data processing system having a storage device for preventing subsequent data loss in storage blocks surrounding a damaged one and for preventing data from being stored in the surrounding blocks with higher probabilities of breaking down.

2. Related Art

Normal hard disk drives (HDD's) may encounter various kinds of problems after long-time use. The problem of bad sectors (i.e., damaged storage blocks) is the most common one. Bad sectors are further divided into logical bad sectors and physical bad sectors. The former are soft bad sectors, usually resulted from software operation or inappropriate uses and recoverable by software. The latter are persistent damages to the sectors. It means that physical damages occur to the HDD sectors. This can only be solved by partitioning the HDD.

During the operation, if there is a damaged storage block in the HDD, its surrounding storage blocks have high probabilities of breaking down than others. Therefore, if no measure is taken immediately to recover or back up data in the damaged storage block, then data stored in the surrounding blocks will likely be lost in subsequent operations. Inevitably, the user cannot selectively store data in some specific storage blocks. Therefore, if data are saved into the blocks surrounding a damaged block before they are broken, they are very likely to be lost.

Consequently, it is imperative to provide a data protection method for solving the above-mentioned problems. The method should prevent data loss in the blocks surrounding a damaged block and prevent data from being stored in those blocks with higher probabilities of braking down.

### SUMMARY OF THE INVENTION

In view of the foregoing, an objective of the invention is to provide a data protection method for preventing data loss in storage blocks surrounding a damaged block.

Another objective of the invention is to provide a data protection method that prevents data from being stored in the surrounding blocks with higher probabilities of breaking down.

To achieve the above-mentioned objectives, the disclosed data protection method used in a data processing system having a storage device includes the following steps: (1) When a damaged storage block in the storage device is detected, find the storage blocks surrounding it. (2) Determine one by one whether any of the surrounding blocks is also damaged. If so, the procedure finishes. Otherwise, the procedure moves on to step (3). (3) Determine whether the surrounding blocks are in use. If not, then the procedure moves on to step (4). Otherwise, the procedure goes to step (5). (4) Set the surrounding blocks as being in use and the procedure finishes. (5) Search unused storage blocks in the storage device, duplicate the data stored in the surrounding blocks to the unused blocks, and set the unused blocks as being in use. (6) Establish in the data processing system a correspondence relation between the surrounding blocks and the unused blocks. When the data processing system accesses the surrounding blocks, it obtains data stored in the unused blocks through the established correspondence relation.

In a preferred embodiment of the invention, the storage device is an HDD. The data processing system is either a computer system or a server system. Step (1) finds the storage blocks surrounding the damaged block by searching sectors. Step (3) determines whether the surrounding blocks are in use by checking the usage status field of the file allocation table. Step (4) sets the surrounding block as being in use by modifying the usage status field of the file allocation table. Step (5) searches unused storage blocks in the storage device by checking the usage status field of the file allocation table. Step (5) sets the unused storage blocks as being in use by modifying the usage status field of the file allocation table. Step (6) establishes the correspondence relation between the surrounding blocks and the unused blocks by establishing in the data processing system a correspondence table between the surrounding blocks and the unused blocks, so that when the data processing system to accesses the surrounding blocks it obtains the data stored in the unused blocks according to the established correspondence table. Another scheme for step (6) is to change the index nodes (i-nodes) of the surrounding blocks to point to the unused blocks by changing the disk block addresses in the i-nodes. Therefore, when the data processing system is in operation, it directly accesses data in the unused blocks according to the disk block addresses in the i-nodes.

In comparison with the prior art, the disclosed data protection method finds the storage blocks surrounding a damaged storage block once the data processing system detects it. Afterwards, the data processing system checks one by one whether any of the surrounding blocks is damaged. For non-damaged storage blocks, the data processing system further determines whether they are in use. If the surrounding blocks are not in use, the data processing system sets them as being in use. If they are already in use, then unused storage blocks in the storage device are searched. The data in the surrounding blocks are then duplicated into the unused blocks. These unused blocks are then set as being in use. Finally, the data processing system establishes a correspondence relation between the surrounding blocks and the unused blocks. When the data processing system accesses the surrounding blocks, it obtains data stored in the unused blocks through the established correspondence relation. This correspondence relation is establishes as the data processing system modifies the i-nodes of the surrounding blocks to point to the unused blocks. Therefore, when the data processing system is in operation, it directly access data in the unused blocks following the i-nodes. Not only does the disclosed method protect data already stored in the blocks surrounding a damaged block in subsequent operations, it also prevents data from being stored into the surrounding blocks with higher probabilities of breaking down.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a flowchart of an embodiment of the disclosed data protection method; and

FIG. 2 is a flowchart of another embodiment of the disclosed data protection method.

### DETAILED DESCRIPTION OF THE INVENTION

The present invention will be apparent from the following detailed description, which proceeds with reference to the accompanying drawings, wherein the same references relate to the same elements.

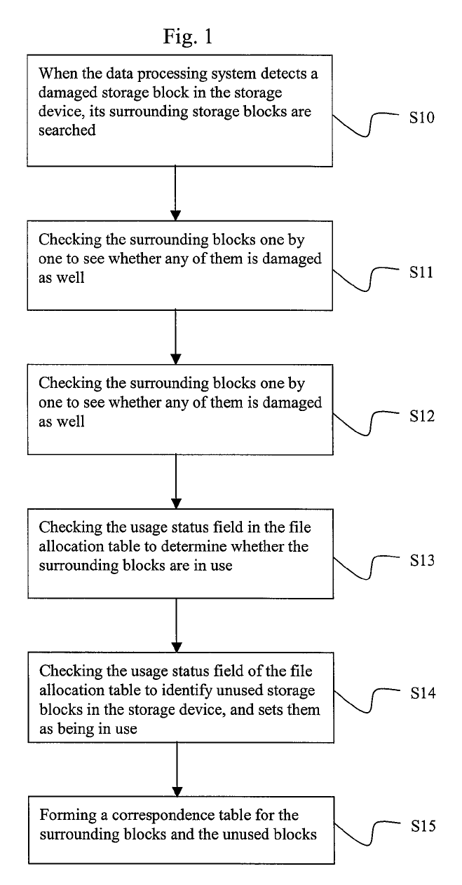

Please refer to FIG. 1. The disclosed data protection method is used in a data processing system having a storage device. In an embodiment of the invention, the storage device is an HDD and the data processing system is either a computer system or a server system that has a storage device. As shown in the drawing, the disclosed method involves steps S10 to S 13. These steps are detailed as follows.

In step S10, when the data processing system detects a damaged storage block in the storage device, its surrounding storage blocks are searched. In this embodiment, step S10 searches HDD sectors to find the surrounding blocks of the damaged block and the number of the surrounding blocks is eight. (Using the concept of a planar diagram, the surrounding blocks are located above, below, to the left, to the right, and at the upper-left, upper-right, lower-left, and lower-right corners of the damaged block.) However, the invention is not limited to this case. The number of surrounding blocks can be increased or decreased in practice (e.g., there are four surrounding blocks above, below, to the left and to the right of the damaged block on a plane).

In step S11, the surrounding blocks are checked one by one to see whether any of them is damaged as well. In this embodiment, the eight surrounding blocks are checked one by one to see if any of them is also damaged. If all the eight surrounding blocks are damaged, then the disclosed method finishes. Otherwise, if one or some of the eight surrounding blocks are not damaged, the procedure continues to step S12.

In step S12, whether the surrounding blocks are in use is determined. In this embodiment, step S12 checks the usage status field in the file allocation table to determine whether the surrounding blocks are in use. That is, the usage status field of each of the good surrounding blocks determined in step S11 in the file allocation table is checked. If the good surrounding block is not in use, then the procedure continues to step S13. Otherwise, if the good surrounding block is detected to be in use, then the procedure goes to step S14.

In step S13, the surrounding blocks are set as being in use. In this embodiment, step S13 modifies the usage status field of the file allocation table to set the surrounding blocks as being in use. That is, the usage status fields of the unused good surrounding blocks determined in step S12 are changed to being in use. The purpose is to prevent new data from being stored into the unused good surrounding blocks in subsequent operations.

In step S14, the data processing system searches unused blocks in the storage device, duplicates data in the surrounding blocks to the unused blocks, and sets the unused blocks as being in use. In this embodiment, step S14 checks the usage status field of the file allocation table to identify unused storage blocks in the storage device, and sets them as being in use by modifying the corresponding usage status fields in the file allocation table. That is, the data stored in the good surrounding blocks determined in step S12 are backed up into other unused blocks. The unused blocks stored with the backup data are set as being in use. The purpose is to back up data already stored in the surrounding blocks and to prevent new data from being stored in these blocks in subsequent operations. In this case, the usage status of the good and used surrounding block determined in step S12 is not changed (still in use). Therefore, no new data can be saved into the surrounding blocks in subsequent operations of the data processing system. Step S15 follows.

In step S15, a correspondence between the surrounding blocks and the unused blocks is established in the data processing system. When the data processing system accesses the surrounding blocks, it obtains the data stored in the unused blocks following the established correspondence relation. In this embodiment, step S15 forms a correspondence table for the surrounding blocks and the unused blocks. That is, the corresponding table of the surrounding blocks and the unused blocks contains the correspondence relation between the good surrounding blocks whose data have been backed up and the unused blocks stored with the backup data in step S14. Therefore, when the data processing system accesses the surrounding blocks, it obtains the data stored in the unused blocks following the established correspondence table.

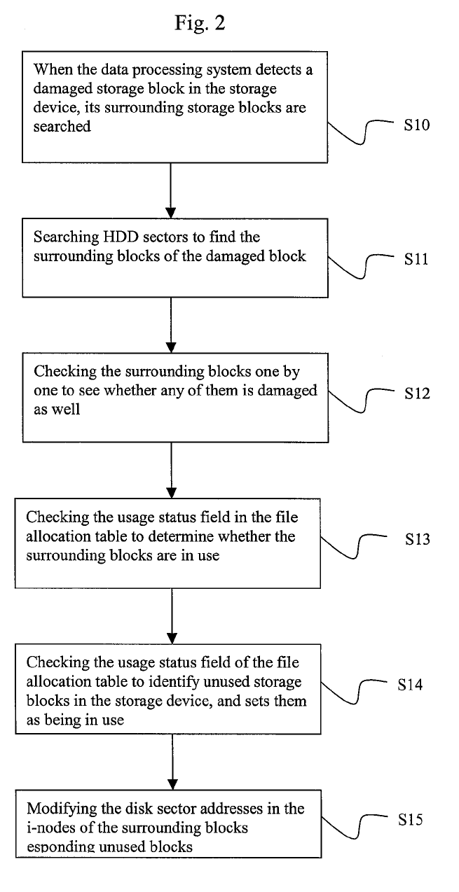

FIG. 2 is a schematic view of the flowchart for another embodiment of the disclosed data protection method. In this embodiment, steps S10 to S14 are the same as those in FIG. 1. In step S15, the data processing system modifies the i-nodes of the surrounding blocks to point to the unused blocks. When the data processing system is in operation, it directly accesses the data in the unused blocks following the i-nodes. Generally speaking, the information recorded in the i-nodes includes: size of file, user ID, group ID, file access mode, link count, file last modified time, and disk sector address. In this embodiment, step S15 modifies the disk sector addresses in the i-nodes of the surrounding blocks so that the i-nodes thereof point to the corresponding unused blocks. That is, only the i-nodes of the in-use undamaged surrounding blocks with data being backed up in step S14 are changed to point to the unused blocks. Therefore, when the data processing system is in operation, it directly accesses the data in the unused blocks following the disk sector addresses in the i-nodes.

In summary, the disclosed data protection method is as follows. When the data processing system detects a damaged storage block, it finds the storage blocks surrounding it. Afterwards, the data processing system checks one by one whether any of the surrounding blocks is damaged. For non-damaged storage blocks, the data processing system further determines whether they are in use. If the surrounding blocks are not in use, the data processing system sets them as being in use. If they are already in use, then unused storage blocks in the storage device are searched. The data in the surrounding blocks are then duplicated into the unused blocks. These unused blocks are then set as being in use. Finally, the data processing system establishes a correspondence relation between the surrounding blocks and the unused blocks. When the data processing system accesses the surrounding blocks, it obtains data stored in the unused blocks through the established correspondence relation. Alternatively, the i-nodes of the surrounding blocks in the data processing system are modified to point to the unused blocks. Therefore, when the data processing system is in operation, it directly access data in the unused blocks following the i-nodes. Not only does the disclosed method protect data already stored in the blocks surrounding a damaged block in subsequent operations, it also prevents data from being stored into the surrounding blocks with higher probabilities of breaking down.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of data protection used in a data processing system having a storage device, the method comprising the steps of:
(1) finding surrounding storage blocks of a damaged storage block when the data processing system reads the damaged storage block in the storage device;
(2) determining in sequence whether any of the surrounding blocks is also damaged and finishing the method if there is or proceeding to step (3) otherwise;
(3) determining whether the surrounding blocks are in use and proceeding to step (5) if they are or proceeding to step (4) if they are not;
(4) setting the surrounding blocks as being in use and finishing the method;
(5) searching first unused blocks in the storage device, duplicating the data in the surrounding blocks to the first unused blocks, and setting the first unused blocks as being in use; and
(6) establishing a correspondence relation between the surrounding blocks and the first unused blocks, so that when the data processing system accesses the surrounding blocks it directly obtains the data stored in the first unused blocks following the established correspondence relation.

2. The method of claim 1, wherein the storage device is a hard disk drive (HDD).

3. The method of claim 1, wherein the data processing system is selected from the group consisting of a computer system and a server system.

4. The method of claim 1, wherein step (1) finds the surrounding blocks by searching the hard disk sectors.

5. The method of claim 1, wherein step (3) checks the usage status field of the file allocation table to determine whether the surrounding blocks are in use.

6. The method of claim 1, wherein step (4) sets the surrounding blocks as being in use by modifying the usage status field of the file allocation table.

7. The method of claim 1, wherein step (5) searches the first unused blocks in the storage device by checking the usage status field of the file allocation table.

8. The method of claim 1, wherein step (5) sets the first unused blocks as being in use by modifying the usage status field of the file allocation table.

9. The method of claim 1, wherein step (6) establishes in the data processing system a correspondence table between the surrounding blocks and the first unused blocks so that when the data processing system accesses the surrounding blocks it directly obtains the data stored in the first unused blocks following the established correspondence table.

10. A method of data protection used in a data processing system having a storage device, the method comprising the steps of:
(1) finding surrounding storage blocks of a damaged storage block when the data processing system reads the damaged storage block in the storage device;
(2) determining in sequence whether any of the surrounding blocks is also damaged and finishing the method if there is or proceeding to step (3) otherwise;
(3) determining whether the surrounding blocks are in use and proceeding to step (5) if they are or proceeding to step (4) if they are not;
(4) setting the surrounding blocks as being in use and finishing the method;
(5) searching first unused blocks in the storage device, duplicating the data in the surrounding blocks to the first unused blocks, and setting the first unused blocks as being in use; and
(6) modifying the i-nodes of the surrounding blocks in the data processing system to point to the first unused blocks, so that when the data processing system accesses the surrounding blocks it directly obtains the data stored in the first unused blocks following the i-nodes.

11. The method of claim 10, wherein step (6) modifies the disk sector addresses in the i-nodes of the surrounding blocks to point to the first unused blocks, so that when the data processing system accesses the surrounding blocks it directly obtains the data stored in the first unused blocks following the i-nodes.
